(19) United States
(12) Patent Application Publication
(10) Pub. No.: US 2003/0208923 A1
(43) Pub. Date: Nov. 13, 2003

(54) High temperature dehumidification drying system

(76) Inventor: Donald C. Lewis, Bangor, ME (US)

Correspondence Address: BOHAN, MATHERS & ASSOCIATES, LLC, PO BOX 17707, PORTLAND, ME, 04112-8707, US

(21) Appl. No.: 10/402,007

(22) Filed: Mar. 28, 2003

Related U.S. Application Data
(60) Provisional application No. 60/369,164, filed on Apr. 1, 2002.

(51) Int. Cl. F25D 17/06; F26B 3/00

(52) U.S. Cl. 34/471; 62/93

(57) ABSTRACT

A dehumidification dryer configured and operated so at to achieve higher drying temperatures than traditionally obtainable with dehumidification driers. The invention takes advantage of refrigerants not previously used in the field of dehumidification drying to achieve temperatures in the range of 180-225° F. that previously were found only in open hot air kilns, open commercial clothes driers, and other apparatus of high throughput. In order to make optimum use of high-temperature refrigerants, the invention uses variable control rates for drying the air that is used as the drying medium, and restructures the deployment of the components of the refrigeration circuit that participates in the heat and humidity exchange central to the operation of the drier.

This application claims the benefit under 35 U.S.C. § 119(e) of the Provisional Application No. 60/391,164, filed on Apr. 1, 2002.

### BACKGROUND OF THE INVENTION

1. Field of the Invention

The present invention relates generally to systems for drying objects and materials. In particular, the present invention relates to such systems that employ heat exchangers incorporating refrigeration cycles and do not openly exhaust heat and water vapor to the ambient atmosphere. More particularly, the present invention is directed at providing such systems that can operate at drying temperatures considerably higher than has been possible heretofore for dehumidification dryers. More particularly yet, the present invention is directed at providing such systems in which the objects and materials to be dried can be maintained during the drying process at temperatures as high as 225° F.

2. Description of the Prior Art

Although all drying involves “dehumidification” of the object to be dried, the term is used in the industry to refer to systems that heat the objects to be dried by circulating a hot, relatively dry atmosphere past and through them, and then conveying that atmosphere into a dewatering region for drying before re-introducing it to the objects to be dried. In this way, the drying atmosphere arrives in the drying region with relatively low humidity and leaves it containing water vapor evaporated from the objects to be dried. Dehumidification dryers are generally closed systems, in contrast to drying systems where the objects to be dried are simply heated to a high temperature and the resulting gaseous water (a “greenhouse gas”) being vented into the ambient atmosphere along with volatile organic compounds (VOCs) and other pollutants. Also, being closed systems, the dehumidifiers do not discard the large quantities of heat (energy) that are vented by the traditional systems, and hence are considerably less expensive to operate.

In the field of industrial drying, the use of refrigeration apparatus as an integral part of dehumidification equipment is well known. The dewatering process typically draws the warm, humid air departing the drying region across a refrigeration coil through which liquid refrigerant is circulated. Heat is conveyed from the warm moist air past the coil, where this heat is transferred to the refrigerant, serving as the heat of vaporization that converts the liquid refrigerant into a gas. For this reason, the coil is referred to as the “evaporator” portion of the refrigeration circuit, or simply, the evaporator.

Overall, the refrigeration circuit includes the evaporator followed by a compressor, where the now-gaseous refrigerant is compressed, and a condenser, where the refrigerants heat of vaporization is shed and the refrigerant is reconverted to a liquid. In order for the drying atmosphere to be dewatered, its temperature must be cooled at the evaporator to a temperature below its dew point. Once it has passed that point, it is reheated before being returned to the object to be dried, the reheating being done in whole or in part by the heat coming off the refrigeration circuit's compressor.

In spite of the efficiencies and other desirable features offered by the dehumidification dryer, it has had relatively limited use in large-scale drying, be it in the lumber industry, commercial clothes drying, or elsewhere. This is because of the limitations on the operating temperatures hitherto attainable by dehumidification dryers. For temperatures demanded for certain commercial drying operations the available refrigerants break down chemically or become ineffective for other reasons, including the high pressures they rise to upon receiving drying atmospheres at these high—to the point where the resulting load placed on the compressor motor causes that motor to fail. For these reasons, straight dehumidification dryers were limited to a maximum drying temperature of about 120° F., whereby they were precluded from use in a large number of drying operations.

By “straight dehumidification” is meant that all of the atmosphere (air) leaving the drying region is passed over the evaporator for dewatering. If the temperature of that air upon arriving at the evaporator exceeds about 120° F., the heat that must be transferred to the refrigerant in order to lower the air's temperature to its dew point causes a breakdown of the refrigeration sequence, for the reasons just stated. This problem was partially alleviated by the modifications taught by Lewis, U.S. Pat. Re. No. 31,633 (1984), which coupled a feedback mechanism to an air-diverting scheme, whereby the volume of air being introduced to the refrigeration unit per unit time is varied as a function of the leaving air or refrigerant temperature. By putting a cap on the amount of heat being dumped into the refrigerant, the drying atmosphere (and hence the objects to be dried) could be raised to higher temperatures.

In particular, in the Lewis drying apparatus, the air-intake to the dewatering region includes mechanism for variably diverting a fraction of the air coming from the drying region, so that that fraction does not come into contact with the coil. The goal is to keep the temperature of the refrigerant or air leaving the coil below a pre-defined level. This is done by coupling the diversion mechanism to a sensor monitoring the temperature directly, or monitoring some surrogate for it. When the monitored temperature exceeds its preset maximum, an increased fraction of the humid air coming from the drying region is diverted around the coil, thus reducing the heat load that the coil has to handle. The system of Lewis therefore permits higher drying temperatures to be used while retaining the advantages of the closed-system dehumidifier. In addition to permitting higher drying temperatures, it allows a much more efficient use of “cooling” energy toward the end of the drying regime, when the humid air is far less humid that at the outset of the regime. During that stage in the drying, the difference between the air temperature and the dew point may be quite large with the result that in order to condense water out of that air, it is necessary to lower the temperature of the air many degrees. In this case, even if the temperature of the air exiting the drying region does not exceed the maximum operating temperature of the refrigerant, straight dehumidification schemes may not work, simply because the circuit is unable to remove enough heat to lower the temperature of the complete flux of the drying atmosphere below that atmosphere's dew point. If the air flows past the evaporator without being lowered in temperature below its dew point, it emerges with the same absolute humidity that it had upon entry and consequently will serve no further drying function upon being reheated and directed across the object to be dried. Under these circumstances, the diversion system of Lewis again comes to the rescue. By permitting just a small fraction of the total drying-atmosphere flux to contact the coil, that fraction can be reduced to below its dew point and hence dewatered. This will result in an overall reduction of humidity of the entire flux of the air once it has been reunited for its next pass across the objects to be dried. This not only allows the conventional drying schedules for some woods to be met with a dehumidification drying system, but allows all substances to be dried in dramatically shortened times, and without the costs in energy and pollution that are associated with open systems. The system of Lewis permits drying temperatures as high as 160° F. to be reached while using conventional refrigerants such as CFC12 or the various substitutes for CFC12.

Even though dehumidification dryers at drying temperatures as high as 160° F. represent a great improvement, there still remain certain woods and other materials that require even higher temperatures at least in some portion of their normal drying schedules. Temperatures of 180° F. and higher are needed for those materials. And it is not just with respect to certain types of wood that 160° F. is lower than the optimal drying temperature; it is also true for materials ranging from clothing to various pharmaceutical compounds. Even for those materials that do not require the higher temperatures, the drying speed is normally increased by going to higher temperatures. That is, whenever the drying temperature is increased, the rate of drying available for all objects to be dried goes up dramatically, regardless of whether they require the high temperatures to permit them to be dried in accord with a conventional drying schedule. Given the exigencies related to minimizing all kinds of pollution and maintaining energy efficiency, any improvement in drying systems must involve closed systems or systems considerably more closed that the conventional ones, regardless of its detailed structure and operation. Although closed-system commercial clothes dryers incorporating a refrigeration circuit do exist, they have not been able to be operated at the temperatures available to open clothes-drying systems, for the same reasons that kilns have not.

Therefore, what is needed is a closed drying system that permits drying temperatures significantly above 160° F. to be maintained. What is also needed is such a closed drying system that can be incorporated relatively easily into existing closed-system drying apparatus, and in particular to dehumidification dryers.

### SUMMARY OF THE INVENTION

The present invention is an improvement over the dehumidification dryer taught by U.S. Pat. Re. No. 31,633 (1984), which issued to and is owned by the present inventor and is hereby incorporated into the present specification.

It is an objective of the present invention to produce a closed drying system that permits conventional drying schedules for most types of wood and other objects to be maintained. It is a further objective of this invention that the improvements provided herein can be easily introduced to existing dehumidifier drying systems..

The stated objectives are met by modifying the current dehumidification drying systems so that they can tolerate significantly higher temperatures, and then by elevating the drying region to higher temperatures. Making the systems tolerant involves two steps. The first is to move out of the drying enclosure those components that can be harmed by exposure to temperatures in excess of 160° F. The second is to replace the present refrigerants with a refrigerant that can function at temperatures well above 200 degrees Fahrenheit. This means that the refrigerant will not break down at those temperatures and that its critical pressure is relatively low. The refrigerants that have been available to dehumidifier driers traditionally have been of a nature that they would break down at these temperatures, ceasing to act as an efficient refrigerant and/or causing other problems such as pressure rises at the compressor such that the compressor motors would overload and burn out.

The invention introduces into the field of dehumidification drying R236fa (1,1,1,3,3,3-hexafluoropropane). Though it has hardly been used before the development of the present invention, its only prior use known to the inventor being in conjunction with certain fire extinguishers and in some context with submarines, R236fa is a refrigerant with good high-temperature performance properties.

R236fa has a high critical temperature (256.9° F.) and a relatively low critical pressure, making it ideal for use in a refrigeration circuit dedicated to cooling air from initial temperatures far higher than 160° F., and yet retaining the same refrigeration-circuit components that are in use in presently existing dryers. (Other high-temperature refrigerants have operating pressures that are too high to be compatible with present components, which would therefore have to be replaced if those refrigerant were to be accommodated.) Indeed, when used in a dehumidification kiln, one of the embodiments of the invention, the objects to be dried can be maintained at 225° F., a temperature required by certain conventional drying schedules, for example, for Southern Yellow Pine and Spruce and Fir dimension (construction lumber).

In addition to its kiln embodiment, the present invention will make useful improvements to clothes drying systems, especially commercial dryers, which now are almost exclusively open systems (those continuously exhausting heat and water vapor to the ambient), with all of the energy inefficiencies and potential for polluting that that entails. Such driers constructed or modified in accord with the present invention will be able to reach or exceed the temperatures of conventional open clothes dryers, while providing the benefits of the closed dehumidification system. This means that the drying of clothes, particularly in commercial establishments, can be accomplished in a fraction of the time presently required, and with a lower energy consumption.

In order to make use of high-temperature refrigerants and so obtain the above-described advantages, a number of changes must be made to the traditional dehumidification dryer. The most important of these relate to protecting the components of the traditional system that cannot tolerate the higher temperatures associated with the new systems. Traditionally, and as may be seen in FIG. 1 of Lewis, all of the components were contained within a single enclosure, with little thermal isolation of the various components of the refrigeration cycle from the drying region. For the higher temperature operations that are the target of the present invention, the temperature-sensitive components need to be thermally separated from the drying region, either by insulating them at their present positions within the main enclosure, or by removing them completely from the enclosure, and introducing the piping and other linkage necessary for them to carry out their functions within the overall scheme. In the latter case, there are truly two chambers thermally isolated from one another: the drying chamber and the dewatering chamber.

Because of the inherent advantage of the split-flow/feedback method taught by Lewis, that approach is retained in the new design, modified only to reflect the needs imposed by the higher temperatures in and around the drying chamber.

Indeed, the new system includes a number of features of the traditional dehumidification dryers as modified by Lewis. This includes the variant of placing a blower above the condenser for the purpose of enhancing the movement of the drying atmosphere through the dewatering region. Also, depending on particular needs, a heating coil may be placed above that blower to supplement the heat that the drying atmosphere receives from the condenser so as to further raise the temperature of that atmosphere before it is returned to the objects being dried. Moreover, additional fans and/or blowers may be used to further the circulation of the drying atmosphere between the drying region and the dewatering chamber.

The exact outfitting of the drying chamber will depend on the objects to be dried in it. For example, a dehumidification dryer developed for drying clothes probably would have a tumbler mechanism for holding the clothes-to-be-dried. The drying atmosphere would then be directed past and through this tumbler. One difference between kiln and clothes dryer is dictated by the fact that the former is essentially always inside a building, including residential dwellings. Therefore, it is not acceptable to vent any excess heat and moisture into its surroundings. Since as a matter of course, the heat and moisture inside the drying air, and in particular inside the drying region usually builds up to the point where it needs to be periodically reduced, the clothes dryer embodiment of the invention has a dual condenser system. In addition to the condenser in the refrigeration circuit, used for condensing refrigerant, there is a condenser outside the drying zone that is used to cool the drying air and to remove heat from it, before returning it to the drying stream. However, regardless of the particular embodiment, the dewatering apparatus, and in particular the refrigeration circuit, will be given more thermal separation from that drying region, most commonly by moving it completely outside the enclosure housing the drying region.

Under certain circumstances, for example, where tight environmental controls are exercised over what may be vented into the atmosphere, it may also be necessary to use the dual condenser system for the kiln embodiment of invention as well.

### BRIEF DESCRIPTION OF THE DRAWINGS

FIG. 1 is schematic view of the Preferred Embodiment of the present invention used as a kiln for drying lumber.

FIG. 2 shows the present invention in an embodiment directed at commercial clothes drying.

FIG. 3 is a cutaway view of the clothes-drying structure shown schematically in FIG. 2.

FIG. 4 depicts the Drying Index at 30% relative humidity as a function of the temperature.

### DETAILED DESCRIPTION OF THE INVENTION

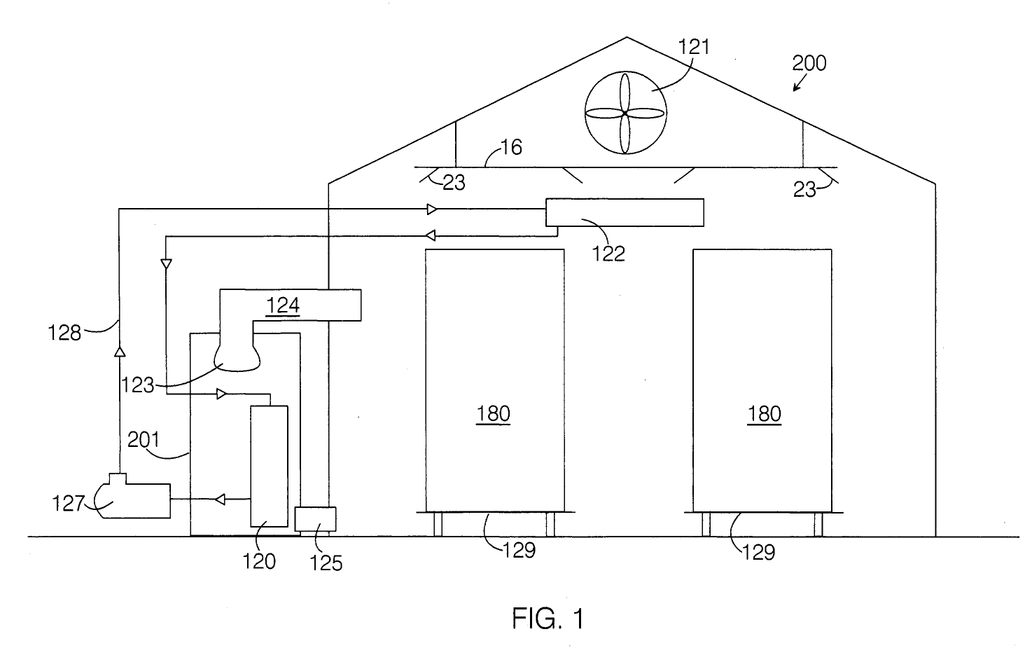

As depicted in FIG. 1, the Preferred Embodiment of the present invention contains a high-temperature enclosure 200 and a dewatering enclosure 201, The high-temperature enclosure 200 contains a drying region 150 and the dewatering enclosure 201 contains an evaporator coil 120. The evaporator coil 120 is part of a refrigeration circuit 128, the other major elements of which are a condenser 122 and a compressor 127. Objects to be dried are contained in the high-temp enclosure 200 but, in contrast to previous dehumidification dryers, most of the refrigeration circuit 128 is not contained therein. The compressor 127 is located at some distance from both the high-temperature enclosure 200 and the dewatering enclosure 201. A diverter blower 123 draws moist, heated air from the high-temperature enclosure 200 through an exit duct 125 and past the evaporator coil 120. Once past the blower 123, the air, now dewatered is returned to the HGH-temperature enclosure through a return duct 124. The diverter blower 123 has a variable speed that is controlled by temperature- and humidity-sensing monitors in a manner similar to that of the system disclosed by Lewis.

The approach just described for establishing the flux of air past the evaporator coil 120 is that of the Preferred Embodiment. Other embodiments of the invention make use of other mechanisms for determining how much of the air from the high-temperature 200 enclosure pass by the evaporator coil 120 per unit time. Indeed, all of the details that are provided in this Section relate to the Preferred Embodiment and should not be taken to be general features of the invention, which can take many specific forms.

The Preferred Embodiment being a kiln, the high-temperature enclosure 200 is of sufficient size to receive one or more stacks of lumber, represented in FIG. 1 by two stacks of lumber 180 supported by pallets 129.

With continuing reference to FIG. 1, a horizontal baffle 16 can be seen to be disposed in the high-temperature enclosure 200 between a ceiling 111 and the lumber 180. The horizontal baffle 16 helps direct the circulation of air with the high-temperature enclosure 200. Air is received into the high-temperature enclosure 200 from the return duct 124 and then circulated around and through the lumber 180. Driving this circulation within the high-temperature enclosure 200 is an array of circulation fans 121 mounted on a linear shaft that is driven from without the high-temperature enclosure 200. In addition to the horizontal baffle 16, a series of diverter baffles 18 depend from the horizontal baffle 16, serving to further control air flow within the high-temperature enclosure 200. As the air moves in a general circular motion throughout the high-temperature enclosure 200, a certain fraction of it is being pulled out through the exit duct 125 and thence to the dewatering enclosure and the evaporator coil 120.

As air is circulated within the high-temperature enclosure 200 as described, it receives heat from the condenser 122 that makes up part of the refrigeration circuit 128. In this manner, heat is continually reintroduced into that atmosphere to compensate for the heat removed from that part of it that is diverted through exit duct 125 onto the evaporator coil 120 and thus cooled and dried. As stated the flux of air per unit time that is cooled and dried is determined by the speed of the diverter blower 123. Thus, the fraction of the total air circulating in the high-temperature enclosure 200 that flows over the evaporator coil 120 is completely controlled by the speed of the diverter blower 123, in the Preferred Embodiment. However, it is because of this manner of determining fractional flow over the coil that the condenser is located in this Preferred Embodiment near to the supplementary fan 22.

In the prior-art embodiment depicted in FIG. 1 of Lewis, the evaporator temperature sensor is located in the air path immediately downstream from the evaporator coil (or in the suction line) and is generally configured so as to control the primary damper and the bypass damper in such a way as to constrain the temperature of the air that has just passed over the evaporator coil to be the same as the temperature of the refrigerant that has just exited the evaporation coil. This ensures that the refrigerant leaves the evaporation coil at a temperature sufficiently low to cool the compressor motor, and yet that the pressure in the evaporator coil is maintained at a level so that the compressor motor continues to operate within its load tolerances.

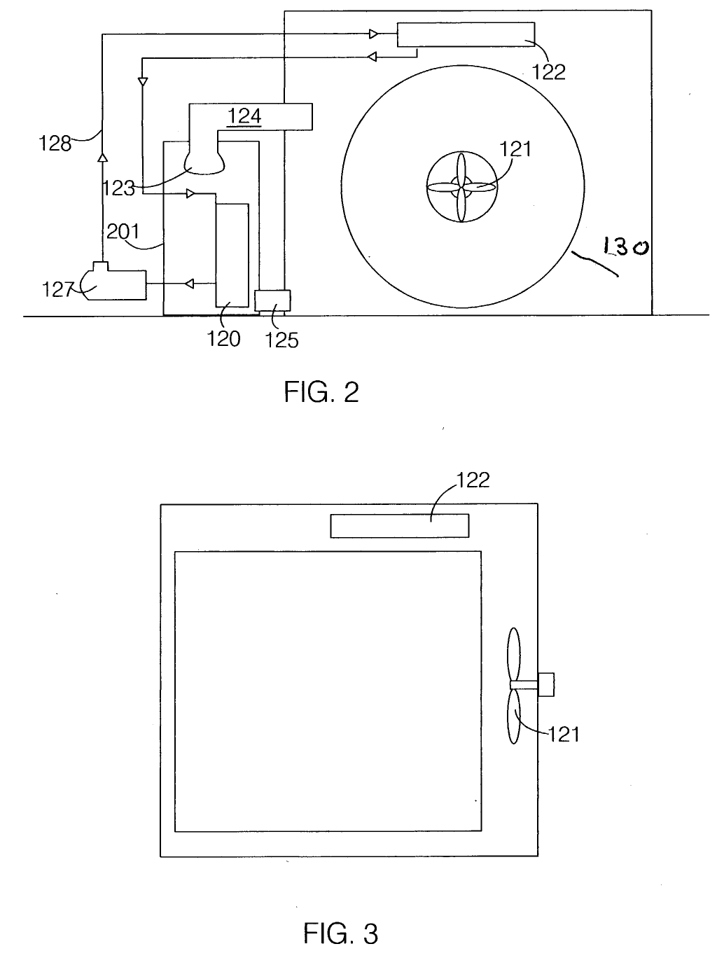

FIG. 2 and FIG. 3 depict variant of the Preferred Embodiment that is directed at high-temperature clothes drying. As with the kiln, the modification that allows drying at temperatures previously attainable only by open systems, involves placing the temperature-vulnerable components of the dehumidification drying system outside the region of high temperatures and then introducing a refrigerant that can function at these high temperatures. As can be seen in FIG. 2, the same basic setup described above for the kiln of the Preferred Embodiment is used with a clothes dryer. The difference in detail is that instead of stacks of lumber inside the high-temperature enclosure, there is now placed a drum 130 that is rotatable by a drum motor (not shown).

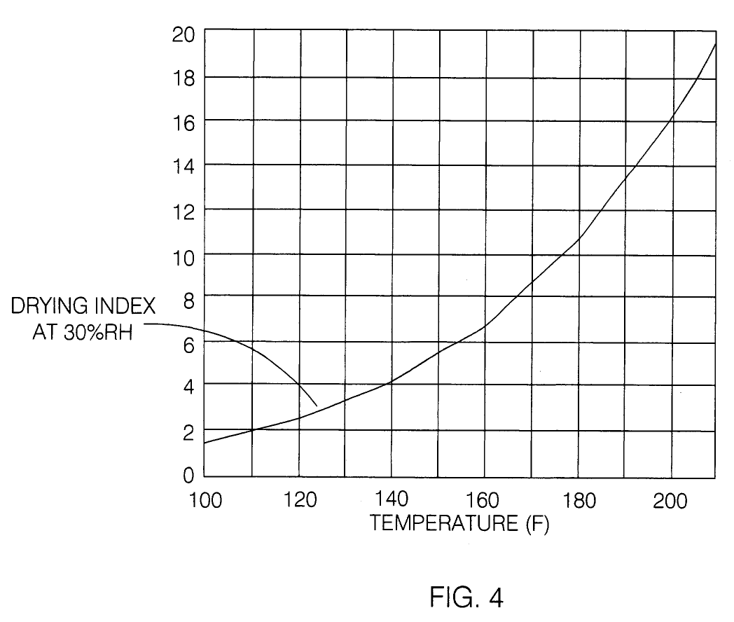

FIG. 4 shows the rapid increase in the Drying Index for the drying air at a particular value of relative humidity (RH). The curve is for 30% RH and assumes that all other conditions than temperature remain the same in and around the object being dried. As an example of the improved drying rates provided by the higher temperatures afforded by the present invention and as an indication of the meaning of the Drying Index (D.I.), contrast what occurs at three different temperatures: 120° F., 160° F. and 200° F. The D.I. at 120° F. is 2.3, 6.7 at 160° F., and 16.4 at 200° F. Thus, the drying time at 160° F. will be about ⅓ (2.3/6.7=0.34) the drying time at 120° F. and at 200° F. the drying time will be about 1/7 (that is, 2.3/16.4=0.14) the drying time at 120° F. Just going from the 160° F. drying temperatures available with Lewis to the 200° F. easily available with the present system, the drying time is cut to less than half.

Some specific characteristics of one embodiment of the present invention have been set out in the foregoing description. From these and from the remainder of the specification, persons skilled in the art can appreciate the broad range of embodiments incorporating the invention. Indeed, this invention can be used with advantage practically wherever high efficiency drying of substances and objects is needed. The various embodiments will reflect the specific nature of the material to be dried, but the underlying principles will be the same.

I claim:

1. A dehumidification dryer comprising a refrigeration circuit incorporating a refrigerant capable of functioning at temperatures in excess of 180° F.

2. The dehumidification dryer as described in claim 1 comprising a high-temperature enclosure wherein objects to be dried are deployable and wherein elements of said refrigeration circuit are excluded from said high-temperature enclosure.

3. The dehumidification dryer as described in claim 2 wherein said refrigeration circuit includes an evaporator coil, a compressor, and a condenser, and wherein said evaporator coil is housed in a dewatering enclosure and wherein said dewatering enclosure is separate from said high-temperature enclosure.

4. The dehumidification dryer as described in claim 3 also including an exit duct providing a means of egress for air from inside said high-temperature enclosure.

5. The dehumidification dryer as described in claim 4 comprising a means for directing moist air to be dewatered from said high-temperature enclosure onto said evaporator coil.

6. The dehumidification dryer as described in claim 5 where said means of directing is subject to a control mechanism for establishing a flux of said moist air wherein said flux is thereby be correlated with a refrigerant temperature at a selected point in said refrigeration circuit.

7. The dehumidification dryer as described in claim 6 wherein said means of directing comprises configuring said exit duct to have an evaporaor-coil end, wherein said evaporator-coil end is inside said dewatering enclosure and in close proximity to said evaporator coil and wherein a variable-speed diversion blower is mounted within a return duct so as to circulate air from said high-temperature enclosure into said dewatering enclosure, past said evaporator coil and back to said high-temperature enclosure.

8. The dehumidification dryer as described in claim 6 wherein said means of directing comprises a diversion damper and a bypass damper, wherein said diversion damper allows a first fraction of said air from said high-temperature enclosure to be directed onto said evaporator coil and wherein said bypass damper allows a second fraction of said air from said high-temperature enclosure to bypass said evaporator coil.

9. The dehumidification dryer as described in claim 6 also including a return duct for conveying dewatered air into said high-temperature enclosure, wherein said dewatered air includes substantially all of said moist air from said high-temperature enclosure after some or all of said moist air has passed over said evaporator coil.

10. The dehumidification dryer as described in claim 9 wherein one or more drying-air circulation fans is used to circulate said dewatered air into and through said objects to be dried in said high-temperature enclosure.

11. The dehumidification dryer as described in claim 6 also comprising an evaporator-coil-to-compressor line, a compressor-to-condenser line, and a condenser-to-evaporator coil line, wherein said evaporator-coil-to-compressor line permits said refrigerant to flow from said evaporator coil to said compressor, wherein said compressor-to-condenser line permits said refrigerant to flow from said compressor to said condenser, and wherein said condenser-to-evaporator coil line permits said refrigerant to flow from said condenser to said evaporator coil.

12. The dehumidification dryer as described in claim 11 wherein said compressor is located outside of both said high-temperature enclosure and said dewatering enclosure.

13. The dryer as described in claim 12 further including a supplemental heater to pre-heat said lumber before activating said dehumidification dryer.

14. The dehumidification dryer as described in claim 12 wherein said refrigerant is 1,1,1,3,3,3-hexafluoropropane (R236fa).

15. The dehumidification dryer as described in claim 14 configured as a kiln for drying lumber in said high-temperature enclosure.

16. The dehumidification dryer as described in claim 15 configured to receive said lumber divided into longitudinal elements wherein said high-temperature enclosure includes a platform wherein said longitudinal elements can be arrayed in a porous stack, such that dewatered air can circulate through and around said longitudinal elements.

17. The dehumidification dryer as described in claim 14 configured as a laundry dryer.

18. The dehumidification dryer as described in claim 17 wherein a clothes-drying chamber is contained in said high-temperature enclosure, wherein said clothes-drying chamber contains a drum for tumbling individual items of clothes so as to expose said items to said dewatered air, said drum having a meshed surface so as to permit said dry air to pass into and through said drum.

19. A method for improved drying of objects in a closed system equipped and configured to continuously circulate heated air between said objects located in a drying region and a refrigeration circuit located in a dewatering region, said method for improved drying comprising the steps of
(a) constructing or reconfiguring a dehumidification dryer so that high-temperature-tolerant components, including certain elements of said refrigeration circuit are thermally separated from said drying region;
b) introducing into said refrigeration circuit a refrigerant able to sustain and to function at temperatures higher than those at which previously available refrigerants could function;
(c) operate said dehumidification dryer at higher temperatures than have been possible for dehumidification dryers incorporating refrigeration circuits within high-temperature regions.
